(19) United States
(12) Patent Application Publication
(10) Pub. No.: US 2012/0000254 A1
(43) Pub. Date: Jan. 5, 2012

(54) MAGNETIC THRUST THEFT-PROOF LABEL

(76) Inventor: Peizi Zhao, Shanghai (CN)

(21) Appl. No.: 13/256,201

(22) PCT Filed: Mar. 10, 2010
(86) PCT No.: PCT/CN10/70951

§ 371 Date: Sep. 14, 2011

(30) Foreign Application Priority Data
Mar. 12, 2009 (CN) 200920068751.1

(51) Int. Cl. E05B 73/00

(52) U.S. Cl. 70/58

(57) ABSTRACT

A magnetic thrust theft-proof label comprises a shell composed of an upper cover and a pedestal. A coil alarm and a theft-proof nail locking mechanism are provided between the upper cover and the pedestal. A theft-proof nail is inserted into the shell from the upper cover and located by the locking mechanism. The locking mechanism comprises a locking bead cap with a trapezoid section, a locking bead fixing seat fitting with the inner cavity of the locking bead cap, no less than three locking beads and a spring component resisting the locking bead fixing seat. A magnetic force switch device is provided on the locking mechanism. A magnetic block in the magnetic force switch device is pushed by a magnet in an unlocking piece to move towards a direction away from the magnet. The magnetic block pushes the locking mechanism to open.

### TECHNICAL FIELD

The present invention relates to a magnetic thrust theft-proof label for use in stores or supermarkets as an anti-theft device.

### BACKGROUND

Theft-proof labels generally refer to certain types of anti-theft devices used in commodity markets. Types of such theft-proof labels may include: lock-based theft-proof labels which can be secured to goods utilizing certain locking mechanisms having specific mechanical structure, and therefore can be unlocked only using corresponding unlocking tools; alarm-based theft-proof labels which can send alarm signals via internally installed electronic or other alarm components; and integrated theft-proof labels which may have the characteristics of the two theft-proof labels mentioned above.

Due to the wide use of the conventional magnetic theft-proof labels, they no longer provide absolutely secure anti-theft capabilities, and they may be easily opened using any magnet. The applicant of the present disclosure have disclosed a safe and convenient theft-proof label in a Chinese utility mode patent (NO. ZL200620045680), which introduced a lateral limit device on the basis of a traditional locking mechanism. Such a theft-proof label requires both lateral and vertical forces in order to unlock. In other words, this safe and convenient theft-proof label is set a lateral magnetic force on a claw having a magnetic block at the bottom, which can be opened by opening the locking mechanism with the magnetic block at the bottom of the claw after opening the limit device on locking mechanism. As a result, the security is greatly enhanced.

However, structures that require both lateral and vertical forces to unlock is slightly more complex. Furthermore, a person with a few pieces of magnetic blocks may be able to open the lateral limit device using one magnetic block first, and then open the locking mechanism with another one. Therefore, a locking mechanism solely based on magnetic forces is not absolutely safe.

### SUMMARY

The present disclosure is directed to a magnetic thrust theft-proof label with new structure, instead of magnetic attraction, which opens the locking mechanisms by magnetic-thrust combined with magnetic switch device on locking mechanisms.

The magnetic thrust theft-proof label in accordance with the present disclosure may include a magnetic thrust theft-proof label comprises a shell composed of an upper cover and a pedestal. A coil alarm and a theft-proof nail locking mechanism are provided between the upper cover and the pedestal. A theft-proof nail is inserted into the shell from the upper cover and located by the locking mechanism. The locking mechanism comprises a locking bead cap with a trapezoid section, a locking bead fixing seat fitting with the inner cavity of the locking bead cap, no less than three locking beads and a spring component resisting the locking bead fixing seat. A magnetic force switch device is provided on the locking mechanism. A magnetic block in the magnetic force switch device is pushed by a magnet in an unlocking piece to move towards a direction away from the magnet. The magnetic block pushes the locking mechanism to open.

The design principle of the present disclosure is: using the magnetic pieces of magnetic force switch device and inside of the unlocking piece related interaction force between the magnets to promote movements of magnetic blocks. In the locked position, a spring component resisting the locking bead fixing seat, as the locking bead fixing seat fits with the inner cavity of the locking bead cap with a trapezoid section, the locking bead cap compress the locking bead radial through holes in the locking bead fixing seat, thereby securing the theft-proof nail positioned through the locking bead fixing seat. When the magnetic block pushes the locking mechanism, the locking bead fixing seat is pushed downward, break away from the locking bead cap, and the locking bead is no longer subject to locking bead cap radial pressure and thus the locking nail is released. When the unlocking piece is moved away from the thrust theft-proof label, under the resist of spring component, the locking bead fixing seat re-enters the locking bead cap, and the locking mechanism is reengaged.

Based on the design principle described above, a magnetic force switch device may be provided for push the locking bead fixing seat. Such a magnetic force switch device may include at least one magnetic block located in the shell and a slide block driven by the magnetic block, wherein the locking bead fixing seat is equipped with the under pressure part, the slide block is set on the under pressure part.

Based on the design principle described above, a specific theft-proof label structure may be provided. The slide block may be formed by a horizontal ring arm and a straight arm extending downwards from the ring arm. The sleeve of the ring arm may set under the pressured part of the fixing seat. The ring arm may be equipped with a pair of rotational support points; the magnetic block set inside of a lower portion of the straight arm, the bottom of the magnet block set at the fixed position of the pedestal; the magnetic block is able to slide along the straight arm in response to magnetic forces, allowing the magnetic block to break away from the fixed position and push the slide block around the support points, which moves the fixing seat downward and unlocks the locking mechanism.

Based on the design principle described above, another specific theft-proof label structure may be provided. The slide block may be formed by horizontal ring arm and a straight arm extending downwards from the ring arm. The sleeve of the ring arm may set under the pressured part of the fixing seat. The ring arm may be equipped with a rotational support point; the magnetic block set on the top of the straight arm; the magnetic block is able to slide along the pedestal in response to magnetic forces, allowing the magnetic block to pivot around the support point, which moves the fixing seat downward and unlocks the locking mechanism.

Based on the design principle described above, a third embodiment of the theft-proof label structure may be provided. The slide block is a horizontal ring part, which sets under the pressured part of the fixing seat. The slide block defines at least one sliding groove, and the bottom of the slide block is sloped. A push block is positioned on top of the magnetic block, which is configured to push the ring part. The magnetic block is able to slide along the pedestal in response to magnetic forces, pushing the push block upwards towards the slide block, and the sloped bottom of the slide block presses the fixing seat down and unlocks the locking mechanism.

Based on the design principle described above, a fourth embodiment of the theft-proof label structure may be provided. The slide block is formed by a set of spiraled sleeves and a pair of rotating arms. The spiraled sleeves are positioned on the outside of the fixing seat, and the bottoms of the spiraled sleeves are sloped. The rotating arms are supported by the shell. One of the rotating arms is set by the spring while the other rotating arm is set by the magnetic block. The magnetic block (may have a sloped top portion) is able to slide along the pedestal in response to magnetic forces, pushing the rotating arms upwards, causing the bottoms of the spiraled sleeves to press the fixing seat down to unlock the locking mechanism. Conversely, the spring may push the rotating arms in an opposite direction, which resets the spiraled sleeves and locks the locking mechanism.

The present disclosure is directed to provide a different kind of magnetic direction to unlock the locking mechanism. It is contemplated that various other structures may be implemented for pushing the locking bead fixing seat structure.

Based on the design principle described above, the described magnetic block may be positioned obliquely, and may be pushed upward obliquely.

Based on the design principle described above, the pressured part of the locking bead fixing seat may include convex bumps or rings. Symmetrical bumps are generally equipped with a pair of downward pressure to maintain balance.

Also disclosed is a ring-type unlocking device to unlock the theft-proof label described above. The unlocking device may include a magnetic block having an inner hole defined thereof. Alternatively, the unlocking device may include two or more magnet blocks that jointly define the inner hole.

### BRIEF DESCRIPTION OF THE DRAWINGS

The numerous advantages of the present invention may be better understood by those skilled in the art by reference to the accompanying figures in which:

FIG. 1 is a cross-sectional view of the implementation example 1;

FIG. 2 is a cross-sectional view of the locking bead fixing seat;

FIG. 3 is a top section view of the slide block of FIG. 1;

FIG. 4 is a cross-sectional view of the slide block of FIG. 1;

FIG. 5 is a cross-sectional view of the implementation example 2;

FIG. 6 is a top section view of slide block of FIG. 4;

FIG. 7 is a cross-sectional view of the slide block of FIG. 4;

FIG. 8 is a cross-sectional view of the implementation example 3;

FIG. 9 is a top section view of the slide block of FIG. 7;

FIG. 10 is a cross-sectional view of the slide block of FIG. 7;

FIG. 11 is a top view of the implementation example 4;

FIG. 12 is a cross-sectional view of the slide block of FIG. 11;

FIG. 13 is a cross-sectional view of the unlocking device.

### DETAILED DESCRIPTION

Reference will now be made in detail to the subject matter disclosed, which is illustrated in the accompanying drawings.

### Implementation Example 1

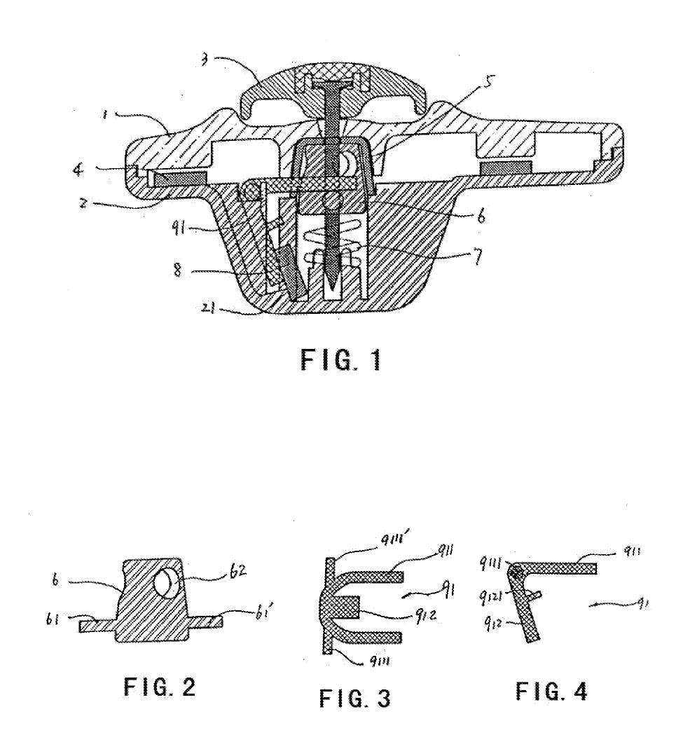

Referring to FIGS. 1 through 4, a magnetic thrust theft-proof label is shown. The magnetic thrust theft-proof label includes a shell composed of an upper cover 1 and a pedestal 2. The magnetic thrust theft-proof label further includes a coil alarm 4 and a theft-proof nail locking mechanism provided between the upper cover 1 and the pedestal 2. A theft-proof nail is inserted into the shell from the upper cover 1 and located by the locking mechanism. The locking mechanism comprises a locking bead cap 5 with a trapezoid section, a locking bead fixing seat 6 fitting with the inner cavity of the locking bead cap 5, no less than three locking beads and a spring component 7 resisting the locking bead fixing seat 6, the locking bead fixing seat 6 with three holes evenly distributed 62 used to set the locking bead. The magnetic locking mechanism corresponds to an unlocking device 10, which may be used to unlock the magnetic locking mechanism. The bottom of the pedestal 2 of thrust theft-proof label is cone-shaped, corresponding to the opening provided on the unlocking device 10. The unlocking piece 10 is equipped with two ring magnets 11.

The locking mechanism has a magnetic force switch device, the magnetic block 8 inside the magnetic force switch device is pushed away from the ring magnet 11 of the unlocking device 10, and the magnetic block 8 pushes open (unlock) the locking mechanism.

The magnetic force switch device includes an obliquely setting magnetic block 8 and a slide block 91 driven by the magnetic block 8. The locking bead fixing seat 6 may include a pair of convex blocks 61 and 61′, and the slide block 91 is located on the top of the convex blocks 61 and 61′.

The slide block 91 includes a horizontal ring arm 911 and a straight arm 912 extending downwards from the ring arm 911. The ring arm 911 is located on the top of the convex blocks 61 and 61′ of the locking bead fixing seat. A pair of rotational support points 9111 and 9111′ are located at the bottom of the ring arm 911, the rotational support points rotatably secure the slide block 91 on the pedestal 2. The magnetic block 8 is located at the near side of the straight arm 912 below the limit block 9121, and engages with the pedestal 2 at the bottom portion 21. The magnetic block 8 is able to slide along the straight arm 912 in response to magnetic forces, move away from the bottom portion 21 and pushes the slide block 91, which may pivot about support points 9111 and 9111′. The ring arm 911 then presses the convex blocks 61 and 61′ downward, causing the locking bead fixing seat 6 to break away from the locking bead cap 5 in response to the pressure, unlocking the locking mechanism.

When moved away from the unlocking device 10, the magnetic block 8 resets back to the original position, reengages with the bottom portion 21 of the pedestal 2, and pushes the slide block 91 about the pivot points 9111 and 9111′ in reverse, allowing the spring component 7 to push against the locking bead fixing seat 6 upward, locking bead cap 5 push against locking bead to lock the theft-proof nail 3.

### Implementation Example 2

The shell structure, locking mechanisms and unlocking device 10 in implementation example 2 may be identical to the implementation example 1.

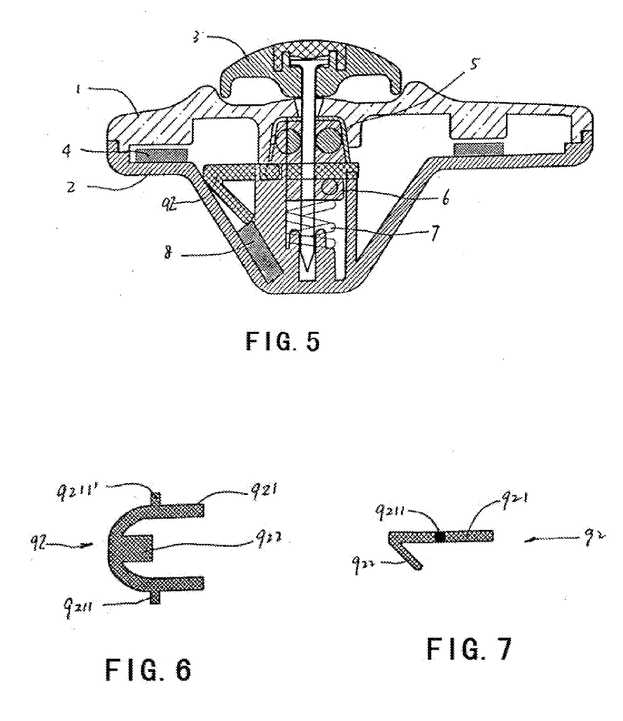

Referring to FIGS. 5 through 7, the locking mechanisms with magnetic force switch device is shown. The magnetic block 8 may be pushed away from ring magnet 11 of the unlocking device 10, allowing the magnetic block 8 to push the locking mechanism open.

The magnetic force switch device includes an obliquely setting magnetic block 8 and a slide block 92 driven by magnetic block 8. The locking bead fixing seat 6 may include a pair of convex blocks 61 and 61′, and the slide block 92 is located on the top of the convex blocks 61 and 61′.

The slide block 92 includes a horizontal ring arm 921 and a straight arm 922 extending downwards from the ring arm 921. The ring arm 921 is located on the top of the convex blocks 61 and 61′ of the locking bead fixing seat. A pair of rotational support points 9211 and 9211′ are located in the middle section of the ring arm 921, the rotational support points rotatably secure the slide block 92 on the pedestal 2. The straight arm 922 is located at the top of the magnetic block 8, which may slide upwardly along the pedestal 2 and push the slide block 92, causing the slide block to pivot about support points 9211 and 9211′. The ring arm 921 then presses the convex blocks 61 and 61′ downward, causing the locking bead fixing seat 6 to break away from the locking bead cap 5 in response to the pressure, unlocking the locking mechanism.

When moved away from the unlocking device 10, the magnetic block 8 resets back to the original position, and pushes the slide block 92 about the pivot points 9211 and 9211′ in reverse, allowing the spring component 7 to push against the locking bead fixing seat 6 upward, locking bead cap 5 push against locking bead to lock the theft-proof nail 3.

### Implementation Example 3

The shell structure, locking mechanisms and unlocking device 10 in implementation example 3 may be identical to the implementation example 1.

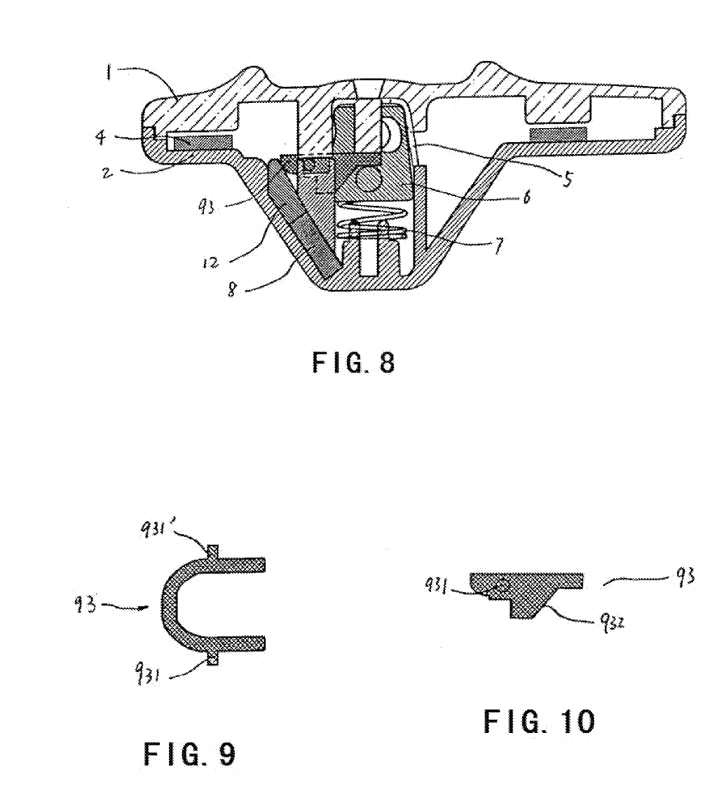

Referring to FIGS. 8 through 10, the locking mechanisms with magnetic force switch device is shown. The magnetic block 8 may be pushed away from ring magnet 11 of the unlocking device 10, allowing the magnetic block 8 to push the locking mechanism open.

The magnetic force switch device includes an obliquely setting magnetic block 8 and a slide block 93 driven by magnetic block 8. The locking bead fixing seat 6 may include a pair of convex blocks 61 and 61′, and the slide block 93 is located on the top of the convex blocks 61 and 61′.

The slide block 93 is a horizontal ring component located at the top of the convex blocks 61 and 61′ of the locking bead fixing seat. A pair of support points 931 and 931′ are located in the middle section of the ring component, the support points slidably secure the slide block 93 on the pedestal 2. The bottom of the slide block 93 has a sloped surface 932. A push block 12 for engaging with the ring component is positioned on top of the magnetic block 8. The magnetic block 8 is able to slide along the pedestal 2, pushing the push block 12 against the slide block 93, causing the slide block 93 to slide horizontally and the sloped bottom 932 of the slide block presses the convex blocks 61 and 61′ downward, unlocking the locking mechanism.

When moved away from the unlocking device 10, the magnetic block 8 resets back to the original position, the slide block 93 also slides back to the original position, allowing the spring component 7 to push against the locking bead fixing seat 6 upward, locking bead cap 5 push against locking bead to lock the theft-proof nail 3.

### Implementation Example 4

The shell structure, locking mechanisms and unlocking device 10 in implementation example 4 may be identical to the implementation example 1.

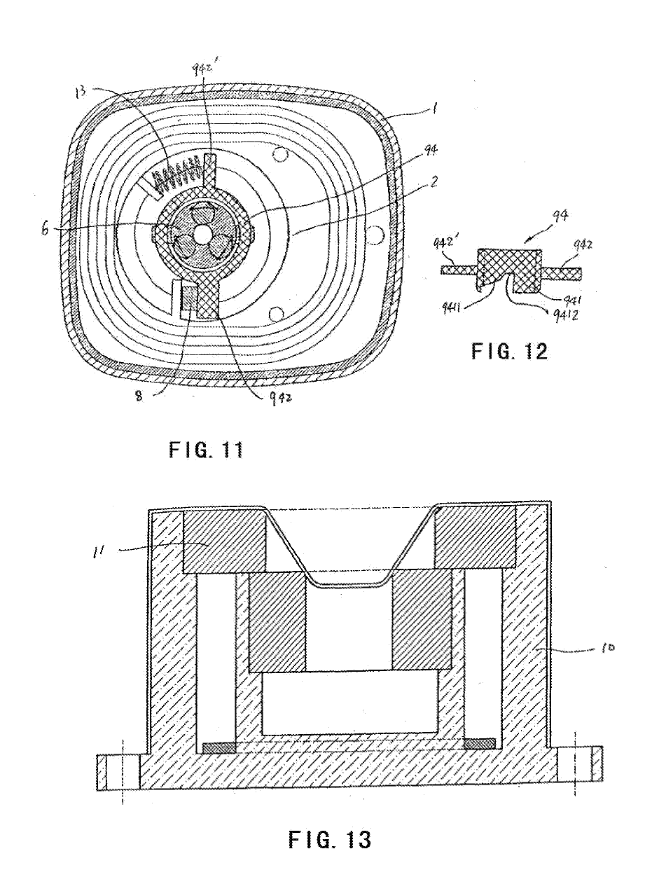

Referring to FIGS. 11 through 12, the locking mechanisms with magnetic force switch device is shown. The magnetic block 8 may be pushed away from ring magnets 11 of the unlocking device 10, allowing the magnetic block 8 push locking mechanisms open.

The magnetic force switch device includes an obliquely setting magnetic block 8 and a slide block 94 driven by magnetic block 8. The locking bead fixing seat 6 may include a pair of convex blocks 61 and 61′, and the slide block 94 is located on the top of the convex blocks 61 and 61′.

The slide block 94 include a set of spiraled sleeves 941 and a pair of symmetrical rotating arms 942 and 942′. The spiraled sleeves 941 are positioned on the outside of the locking bead fixing seat 6, and the bottom of the spiraled sleeves are sloped 9411 and have two gaps 9412 defined thereof.

The gaps 9412 are positioned on the top of the convex blockx 61 and 61′. The rotating arms 942 and 942′ are supported by the pedestal 2. One of the rotating arms 942′ is located by the spring 13 while the other rotating arm 942 is located by the magnetic block 8. The magnetic block 8 (may have a sloped top portion) is able to slide along the pedestal 2, pushing the rotating arm 942 upwards, causing the spiraled sleeve 941 to rotate, and the bottom of the spiraled sleeve 9411 presses the fixing seat down to unlock the locking mechanism.

When moved away from the unlocking device 10, the magnetic block 8 resets back to the original position, the spring 13 pushes the rotating arm 942′ backwards, causing the spiraled sleeve 941 to reset back to the original position and moves the sloped surface 9411 away from the pair of convex blocks 61 and 61′, allowing the spring component 7 to push against the locking bead fixing seat 6 upward, locking bead cap 5 push against locking bead to lock the theft-proof nail 3.

What is claimed is:

1. A magnetic thrust theft-proof label, comprising:
a shell composed of an upper cover and a pedestal;
a coil alarm and a theft-proof nail locking mechanism provided between the upper cover and the pedestal;
a theft-proof nail inserted into the shell from the upper cover and located by the locking mechanism; and
a locking mechanism with a trapezoid section, a locking bead fixing seat fitting with the inner cavity of the locking bead cap, no less than three locking beads and a spring component resisting the locking bead fixing seat;
wherein a magnetic force switch device is provided on the locking mechanism, the magnetic force switch device including a magnetic block, the magnetic block is pushed by a magnet in an unlocking device to move towards a direction away from the magnet.

2. A magnetic thrust theft-proof label as claimed in claim 1, wherein: said magnetic switch device located in the shell includes at least one magnetic block and a slide block driven by the magnetic block, wherein the locking bead fixing seat is equipped with a pressure-responsive part, the slide block is set on the pressure-responsive part.

3. A magnetic thrust theft-proof label as claimed in claim 2, wherein: said slide block includes a horizontal ring arm and a straight arm extending downwards from the ring arm, the ring arm sets on the pressure-responsive part of the locking bead fixing seat, the ring arm having a pair of rotational support points, the pair of rotational support points rotatably secures the slide block to the shell; the magnetic block is located along the straight arm below a limit block and engages with a bottom of the pedestal; the magnetic block being slidable along the straight arm, moving away from the bottom of the pedestal and pushing the ring arm of the slide block against the pressure-responsive part of the locking bead fixing seat.

4. A magnetic thrust theft-proof label as claimed in claim 2, wherein: said slide block includes a horizontal ring arm and a straight arm extending downwards from the ring arm, the ring arm sets on the pressure-responsive part of the locking bead fixing seat, the ring arm having a pair of rotational support points, the pair of rotational support points rotatably secures the slide block to the shell; the magnetic block is located below the straight arm; the magnetic block being slidable upwards away from the bottom of the pedestal and pushing the ring arm of the slide block against the pressure-responsive part of the locking bead fixing seat.

5. A magnetic thrust theft-proof label as claimed in claim 2, wherein: said slide block is a horizontal ring component, the ring component sets on the pressure-responsive part of the locking bead fixing seat, the ring component having support points slidably securing the ring component to the shell, the ring component having a sloped bottom; a push block for engaging with the ring component is positioned on top of the magnetic block; the magnetic block being slidable upwards away from the bottom of the pedestal and pushing the push block against the slide block, causing the ring component of the slide block to slide towards the pressure-responsive part of the locking bead fixing seat.

6. A magnetic thrust theft-proof label as claimed in claim 2, wherein: said slide block includes a set of spiraled sleeves and a pair of rotating arms, the spiraled sleeves are positioned on the outside of the locking bead fixing seat, and the bottom of the spiraled sleeves are sloped and have two gaps defined thereof, the bottom of the spiraled sleeves set on the pressure-responsive part of the locking bead fixing seat; the rotating arms are supported by the shell, one of the rotating arms is located by the spring component and the other rotating arm is located by the magnetic block; the magnetic block is able to slide along the pedestal, pushing the rotating arm upwards, causing the spiraled sleeve to rotate, and the bottom of the spiraled sleeve to press against the pressure-responsive part of the locking bead fixing seat.
